(19) United States
(12) Patent Application Publication
(10) Pub. No.: US 2002/0171744 A1
(43) Pub. Date: Nov. 21, 2002

(54) Capturing apparatus, image processing apparatus, image processing method, and computer readable medium recording program

(75) Inventor: Toshihiko Kaku, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/146,481

(22) Filed: May 16, 2002

(30) Foreign Application Priority Data
May 17, 2001 (JP) 2001-148434

(51) Int. Cl. H04N 5/225

(52) U.S. Cl. 348/222.1

(57) ABSTRACT

A capturing apparatus, includes: a capturing unit for capturing an image of the subject; an image storage unit for storing the given image; a condition storage unit for storing detection condition to detect a predetermined subject element; and an image processing unit for detecting the image element corresponding to the subject element from the image based on the detection condition and performing an image process for the image based on the detected image element and geometrical shift from a reference so that the geometrical shift is reduced. Geometrical shift of the image can easily be detected and corrected.

This patent application claims priority based on Japanese patent application No. 2001-148434 filed on May 17, 2001, the contents of which are incorporated herein by reference.

### BACKGROUND OF THE INVENTION

1. Field of the Invention

The present invention relates to a capturing apparatus, an image processing apparatus, an image processing method, and a computer readable medium recording a program. More particularly, the present invention relates to a capturing apparatus, an image processing apparatus, an image processing method, and a computer readable medium recording a program for performing an image process based on an image.

2. Description of the Related Art

Geometrical shift sometimes occurs on an image captured in a conventional capturing apparatus. Shift of ground and sky occurs on the captured image in a case where the capturing apparatus is tilted at a time of capture. Image deviation sometimes occurs on the captured image due to a characteristic of a lens, optical system or the like. A subject intended to be captured is sometimes positioned too much at an end of an image and an unnecessary subject such as sky occupies most of the images.

Conventionally, to change geometrical shift for the image with geometrical shift, it is necessary that a photographer recognizes geometrical shift for each captured image and a complicated image process is performed for each image. In this case, since the photographer recognizes shift for each image and the image process is performed, it took time and effort.

### SUMMARY OF THE INVENTION

Therefore, it is an object of the present invention to provide a capturing apparatus, an image processing apparatus, an image processing method and a readable computer medium recording a program. The object is achieved by combinations described in the independent claims. The dependent claims define further advantageous and exemplary combinations of the present invention.

According to the present invention, a capturing apparatus for capturing a subject includes a capturing unit for capturing an image of the subject, a condition storage unit for storing a detection condition to detect a predetermined subject element from the subject, and an image processing unit for detecting the image element corresponding to the subject element from an image based on the detection condition and performing an image process for an image based on geometrical shift of the detected image element from a predetermined reference so that the geometrical shift is reduced.

In an aspect of the present invention, the condition storage unit for storing a detection condition to detect predetermined information of ground and sky; and the image processing unit for reducing shift of at least one of the pieces of information of ground or sky in the image element from the predetermined reference. The image processing unit performs an image process for reducing shift of at least one of the ground or sky information in the image element detected based on the detection condition from the reference as to predetermined ground and sky.

In another aspect of the present invention, the image processing unit detects a plurality of image elements and judges ground or sky of an image based on the detected plurality of image elements. The image processing unit judges ground or sky of an image based on an image element whose image region is maximum among the detected plurality of image elements.

In still another aspect of the present invention, the condition storage unit stores the plurality of detection conditions. The image processing unit detects the plurality of image elements based on the plurality of detection conditions and judges ground or sky of an image based on the detected plurality of image elements. The image processing unit assigns weight to the detected plurality of image elements based on the detection condition and judges ground or sky of an image. The image processing unit gives the detected plurality of image elements priority based on the detection condition and judges ground or sky of an image based on the image element of high priority.

In still another aspect of the present invention, the condition storage unit stores the detection condition to detect a face of a person as the subject element. The condition storage unit stores the detection condition to detect sky as the subject element. The condition storage unit stores the detection condition to detect ground as the subject element.

In still another aspect of the present invention, the image storage unit stores an image captured by the image storage unit and information of ground or sky judged by the image processing unit corresponding to the image. The image storage unit stores the image whose geometrical shift is reduced by the image processing unit. The capturing apparatus further includes a display unit for displaying the image stored by the image storage unit and the information of ground and sky corresponding to the image. The capturing apparatus further includes the display unit for displaying the image, whose geometrical shift is reduced, stored by the image storage unit.

In still another aspect of the present invention, the display unit displays images whose plurality of images are zoomed out and the information of ground and sky corresponding to each of the plurality of images. The display unit displays the zoomed-out plurality of images whose geometrical shift is reduced.

According to the present invention, an image processing apparatus for performing an image process for a given image, includes: an image storage unit for storing a given image; a condition storage unit for storing a detection condition to detect a predetermined subject element from an image; an image processing unit for detecting the image element corresponding to the subject element from an image based on the detection condition and performing an image process for an image based on geometrical shift of the detected image element from a predetermined reference so that the geometrical shift is reduced; and a display unit for displaying an image for which an image process is performed by the image processing unit.

According to the present invention, an image processing method for performing an image process for a given image, includes steps of: storing a given image; storing a detection condition to detect a predetermined subject element from an image; and detecting the image element corresponding to the subject element from an image based on the detection condition and performing an image process for an image based on a geometrical shift of the detected image element from a predetermined reference so that the geometrical shift is reduced.

According to the present invention, a computer readable medium recording a program for making an image processing apparatus perform an image process, in which the program makes the image processing apparatus function as units for: storing an image for which an image process is performed; storing a detection condition to detect a predetermined subject element from an image; and detecting the image element corresponding to the subject element from an image based on the detection condition and performing an image process for an image based on a geometrical shift of the detected image element from a predetermined reference so that the geometrical shift is reduced.

According to the present invention, a capturing apparatus for capturing a subject, includes: a capturing unit for capturing an image of the subject; an image storage unit for storing an image captured by the capturing unit; a distance measuring unit for obtaining distance information at each point of a plurality of points of the subject in an image at a time of capturing an image in the capturing unit; and an image processing unit for judging ground or sky of an image based on the distance information obtained by the distance measuring unit.

In an aspect of the present invention the image processing unit judges that a subject showing distance information as far among subjects in image is a sky direction and a subject showing distance information obtained by the distance measuring unit as near is a ground direction. The distance measuring unit obtains distance information of the subject of at least two edges of an image; and the image processing unit judges ground or sky of an image based on a mean value for distance information of each edge obtained by the distance measuring unit. The image processing unit judges that an edge whose mean value for distance information in an image is the sky side.

According to the present invention, an image processing method of performing an image processing for a given image, includes: an image storage unit for storing an image; an image processing unit for receiving distance information at each point of a plurality of points of a subject in an image and for judging ground or sky of an image based on the distance information; and a display unit for displaying an image for which the image processing unit performs an image process.

According to the present invention, an image processing method of performing an image processing for a given image, includes steps of: storing a given image; and receiving distance information at each point of a plurality of points of a subject in an image and for judging ground or sky of an image based on the distance information.

According to the present invention, a computer readable medium recording a program for making an image processing apparatus execute an image process, in which the program makes the image processing apparatus function as units for: storing an image for which an image process is performed; and receiving distance information at each point of a plurality of points of a subject in an image and for judging ground or sky of an image based on the distance information.

This summary of the present invention does not necessarily describe all necessary features so that the invention may also be a sub-combination of these described features.

### BRIEF DESCRIPTION OF THE DRAWINGS

FIG. 1 is a block diagram showing one example of a capturing apparatus 10 according to the present invention.

FIG. 2 is a block diagram for explaining one example of an image process in the capturing apparatus 10.

FIGS. 3A to 3D are views for explaining one example as to the image process in an image processing unit 220.

FIGS. 4A to 4C show an exemplary display in a display unit 240.

FIG. 5 is a block diagram showing one example of an image processing apparatus 300 according to the present invention.

FIG. 6 shows one example of a flowchart as to an image processing method according to the present invention.

FIG. 7 is a block diagram for explaining another example of the image process in capturing apparatus 10.

FIGS. 8A to 8C are views for explaining one example of an image process in an image processing unit 220.

FIG. 9 is a block diagram showing one example of an image processing apparatus 310 according to the present invention.

FIG. 10 shows one example of a flowchart as to an image processing method according to the present invention.

### DETAILED DESCRIPTION OF THE INVENTION

The invention will now be described based on preferred embodiments, which do not intend to limit the scope of the present invention, but rather to exemplify the invention. All of the features and the combinations thereof described in the embodiments are not necessarily essential to the invention.

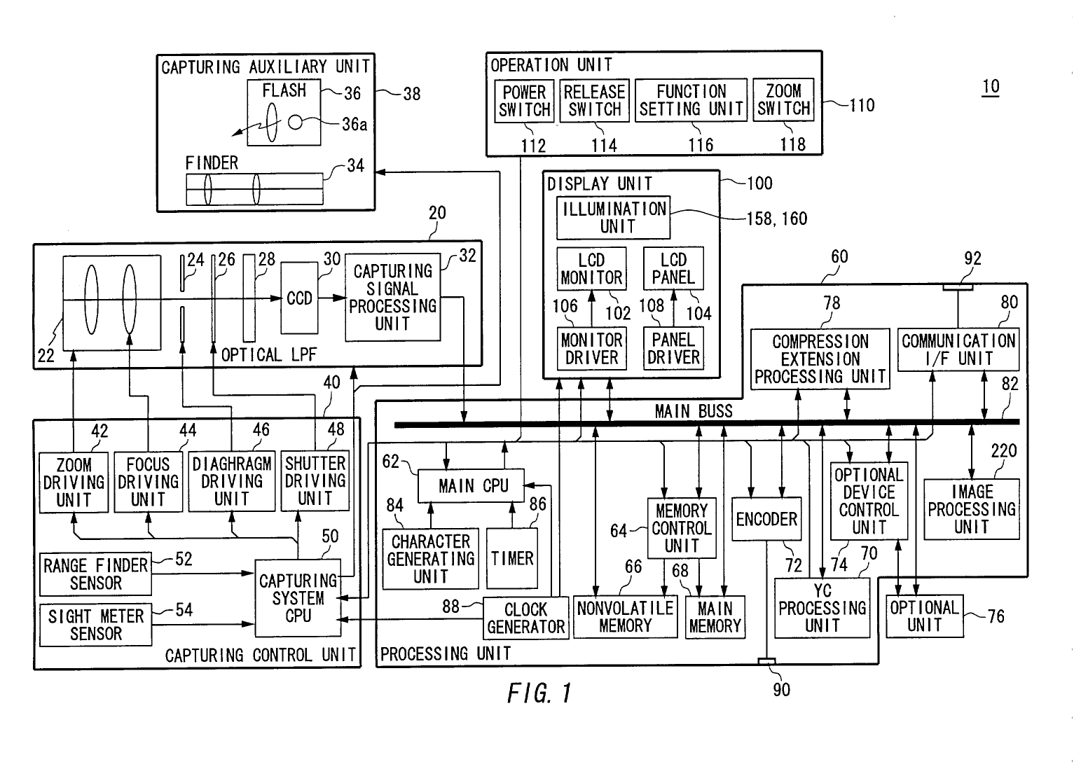

FIG. 1 is a block diagram showing one example of capturing apparatus 10 according to the present invention. Capturing apparatus 10 may be a digital camera as one example. A case where capturing apparatus 10 is the digital camera will be described below. Capturing apparatus 10 is mainly provided with capturing unit 20, capturing auxiliary unit 38, capturing control unit 40, processing unit 60, display unit 100 and operation unit 110.

Capturing unit 20 includes a mechanical member and an electrical member for capturing and image-forming. Capturing unit 20 includes optical system 22 for taking a picture image, diaphragm 24, shutter 26, optical LPF (low pass filter) 28, CCD 30 and capturing signal processing unit 32. Optical system 22 may have a focus lens, zoom lens or any lens. By these components, an image of the subject is image-formed on a receiving surface of CCD 30. Corresponding to a quantity of light of the image of the subject which is image-formed, electric charge is stored in each sensor element (not shown) of CCD 30 (such an electric charge is hereinafter called “storage charge”). The storage charge storage is read out to a shift register (not shown) by a lead gate pulse, and sequentially read out by a register transfer pulse as voltage signal.

In a case where capturing apparatus 10 is a digital camera, capturing apparatus 10 generally includes the function of an electric shutter, and thus a mechanical shutter such as shutter 26 depicted in FIG. 1 is not required. For the electric shutter function, a shutter drain is provided in CCD 30 through a shutter gate. When the shutter gate is driven, the storage charge is output to the shutter drain. By controlling the shutter gate, it is possible to control the time, namely a shutter speed, for storing electric charge in each sensor element.

A voltage signal output from CCD 30, namely an analog signal, is color-divided into R, G, and B components by way of capturing signal processing unit 32, and then a white balance is adjusted at first. Successively, capturing signal processing unit 32 performs gamma compensation. R, G, and B signals are sequentially A/D converted in a necessary timing manner. And, digital picture image data thus obtained is output to processing unit 60.

Capturing auxiliary unit 38 includes finder 34 and flash 36. Finder 34 may include an LCD (not shown). In such a case, various types of information from main CPU 62 described hereinafter can be displayed in finder 34. Flash 36 is operated to irradiate when energy stored in a capacitor (not shown) is supplied to discharge tube 36a of the flash 36.

Capturing control unit 40 has zoom driving unit 42, focus driving unit 44, diaphragm driving unit 46, shutter driving unit 48, capturing system CPU 50 for controlling driving units 42, 44, 46 and 48, region finder sensor 52, and sight meter sensor 54. The driving units such as driving units 42 have a driving mechanism such as stepping motors and the like. Corresponding to a pushing operation of release switch 114, which will be described below, region finder sensor 52 measures a distance to the subject, and sight meter sensor 54 measures the brightness state of the subject. Data of the measured distance (hereinafter “region finder data”) and data of the brightness state of the subject (hereinafter “sight meter data”) are sent to capturing system CPU 50. Capturing system CPU 50 adjusts the focus of optical system 22 by controlling zoom driving units 42 and focus driving unit 44 based on capturing information such as zoom magnification indicated by the user.

Capturing system CPU 50 determines a shutter speed and a value for adjusting a diaphragm size based on digital signals, namely AE information, the integrate value of the RGB of one picture image frame. In accordance with the determined value, diaphragm driving unit 46 adjusts the diaphragm size and shutter driving unit 48 performs the operations of opening and closing shutter 26.

Capturing system CPU 50 controls illumination of flash 36 based on sight meter data and simultaneously adjusts volume of diaphragm 24. When a user instructs the capture of a video, CCD 30 starts to store electric charge, shutter time calculated based on sight meter data is passed, and then stored electric charge is output to capturing signal processing unit 32.

Processing unit 60 includes main CPU 62, memory control unit 64, YC processing unit 70, optional device control unit 74, compression extension processing unit 78, communication I/F unit 80, and image processing unit 220. Main CPU 62 transacts necessary information with capturing system CPU 50 by a serial communication. The clocks that operate main CPU 62 are supplied from clock generator 88. Clock generator 88 provides clocks with respective different frequencies to capturing system CPU 50 and display unit 100.

Character generating unit 84 and timer 86 are provided to main CPU 62 in a parallel manner. Timer 86 is backed up by a battery, and the time of day is counted up continuously. Information as to the capturing time of day and other time information are supplied to main CPU 62 based on this counted value. Character generating unit 84 generates characteristic information such as the capturing time of day, a title, and the like, and this characteristic information is synthesized to capturing an image in a suitable manner.

Memory control unit 64 controls nonvolatile memory 66 and main memory 68. Nonvolatile memory 66 is composed of EEPROM (Electrically Erasable and Programmable ROM), a FLASH memory, and so forth. Data such as setting information by the user and setting at the time of shipping out, which should be kept even if the electric power of capturing apparatus 10 is shut off, are stored therein. It may be possible for a boot program, a system program, etc. of main CPU 62 to be stored in nonvolatile memory 66, if necessary. On the other hand, main memory 68 is composed of a memory, such as DRAM in general, which is comparatively cheap and has a large capacity. Main memory 68 has functionality as a frame memory for storing data output from capturing unit 20, functionality as a system memory for loading various kinds of programs, and functionality as other work areas. Nonvolatile memory 66 and main memory 68 transact data with respective elements inside and outside processing unit 60 through main bus 82.

YC processing unit 70 performs YC conversion to digital image data, and thus generates brightness level signal Y, chromatic (chroma) signal B-Y, and R-Y. The brightness level signal and the chromatic signal are temporally stored in main memory 68 by memory control unit 64. Compression extension processing unit 78 reads out the brightness level signal and the chromatic signal sequentially from main memory 68 and then compresses the signals. The data compressed (hereinafter “compressed data” is simply used) in this way is written out in a memory card, which is a kind of optional unit 76, by way of optional device control unit 74.

Processing unit 60 further has encoder 72. Encoder 72 inputs the brightness level signal and the chromatic signal, the signals are then converted into video signals (NTSC or PAL signals), and then the signals are output from video output terminal 90. When the video signals are generated from data recorded in optional unit 76, the data thereof is supplied to compression extension processing unit 78 by way of optional device control unit 74 at first. Next, data to which a necessary extension process is performed by compression extension processing unit 78 is converted into video signals by way of encoder 72.

Optional device control unit 74 performs signal generation, logical conversion and voltage conversion required between main bus 82 and optional unit 76 in accordance with a signal specification recognized by optional unit 76 and a bus specification of main bus 82. Capturing apparatus 10 may support a standard I/O card based on PCMCIA if desired, for example, other than the above-mentioned memory card as optional unit 76. In such a case, optional device control unit 74 may be formed of a bus control LSI for PCMCIA and so forth.

Communication I/F unit 80 performs a control operation of protocol conversion corresponding to a communication specification, for example, specifications of USB, RS-232C, Ethernet (T.M.), and so forth, supported by capturing apparatus 10. Communication I/F unit 80 includes a driver IC if required, and communicates with external devices including networks through connector 92. It is possible to provide a unique I/F to transact data among external devices such as a printer, a “KARAOKE” player, and a game machine, for example, other than such a standard specification.

Image processing unit 220 performs a predetermined image process for digital image data. For example, image processing unit 220 performs the image process of changing shift of ground and sky in the image for the digital image data, changing deviation of the image due to a characteristic of lens etc., or trimming in a case where the subject to be captured is too close to an end of the image or an necessary subject such as sky occupies most of the image. Image processing unit 220 may perform the image process for the digital image data output by capturing unit 20, and output the digital image data for which the image process is performed to a YC processing unit or main memory 68. Further, the YC processing unit may perform a YC converting process, perform the image process for the digital image data stored in main memory 68, and store the digital image data for which the digital process is performed into main memory 68.

Image processing unit 220 is operated based on the program stored into nonvolatile memory 66 or main memory 68. Memory control unit 64 may receive the program by which image processing unit 220 is operated, from the external devices via communication I/F unit 80, and store the program into nonvolatile memory 66. The program by which image processing unit 220 is operated may receive from optional unit 76 and store the received program into nonvolatile memory 66. The program stored into nonvolatile memory 66 or main memory 68 makes processing unit 60 function as an image obtaining unit to receive the image for which the image process is performed, a condition storage unit to store detection condition to detect a predetermined subject element from the image, and the image processing unit to perform the image process for the image so that geometrical shift is reduced based on geometrical shift of the detected image element from the predetermined reference. The image element corresponding to a subject element is detected based on detection condition. The program may make the image processing apparatus, for example, the computer, or operate a process.

The process performed by processing unit 60 is the same function and operation or similar as/to image processing unit 220, image storage unit 210, and condition storage unit 230; the same function and operation or similar as/to image processing apparatus 300; or the same function or similar as/to the image processing method as described hereinafter.

Display unit 100 includes LCD monitor 102 as one example of a display unit for displaying the image. LCD monitor 102 is controlled by monitor driver 106, which is the LCD driver. LCD monitor 102 is more or less 2 inches in size, for example, and displays a mode of telecommunication and capturing at the present time, telephone number, the residual amount of a battery, the time of day, the screen for setting a mode, subject image, and the received image.

In the present embodiment, display unit 100 further includes illumination units 156 and 158. As previously described above, this is because illumination units 156 and 158 of the present embodiment illuminates using luminous source of LCD monitor 102. Illumination units 156 and 158 have their own luminous source. Illumination units 156 and 158 may be provided in capturing 10 as a constitution element separately from LCD monitor 102.

Operation unit 110 includes a mechanism and an electric member required for the user to set or indicate operation modes of capturing apparatus 10. Power switch 112 determines an ON/OFF condition of the electric power of capturing apparatus 10. Release switch 114 has a pushing structure of a half push and a full push. As an example, AF and AE are locked by the half push, and a captured image is taken by the full push. After necessary signal processing and data compression are performed, the photograph images are recorded in main memory 68, optional unit 76, and so forth. Operation unit 110 may include therein a rotatable mode dial, a plus key and other like switches, and these desires are referenced as a function setting unit 116 in general in FIG. 1. For instance a function or operation designated by operation unit 110 include “File Format”, “Special Effect”, “PrintingImage”, “Decision/Storing”, “Switching adisplay”, and so forth. Zoom switch 118 determines a zoom magnification.

According to the above constitution, main operations are described below. Electric power switch 112 of capturing apparatus 10 is turned ON and electric power is supplied to each unit of the camera. CPU 62 judges that capturing apparatus 10 is either in the capturing mode or the reproducing mode by reading a state of function setting unit 116.

Main CPU 62 monitors a state when the release switch 114 is half pushed. When a half-push of release switch 114 is detected in a case where a stand is closed, CPU 62 obtains sight meter data and region finder data from sight meter sensor 54 and region finder sensor 52, respectively. Capturing control unit 40 is operated based upon the obtained data, and focus or diaphragm of optical system 22 is adjusted. When main CPU 62 detects the half-push, CPU 62 obtains sight meter data from only sight meter sensor 54. Capturing control unit 40 adjusts diaphragm of optical system 22.

Upon completion of adjustment, display of the character such as “standby” on LCD monitor 102 informs the user of completion. Successively, CPU 62 monitors a state where release switch 114 is fully pushed. When release switch 114 is fully pushed, shutter 26 is closed after the shutter button has been pushed for a predetermined time, and storage charge from CCD 30 is output to capturing signal processor 32. Digital image data generated from a resulting process by capturing signal processor 32 are output to main bus 82.

Digital image data are stored into main memory 68 for the moment; after that image processing unit 220, YC processor 70 and processor 78 accept the data processing; and data are recorded into option device 76 via control unit 74. The recorded image is displayed on LCD monitor 102 while the image is frozen and the user can view the captured image on the LCD monitor 102 later. A series of capturing operations are completed.

In a case where capturing apparatus 10 is in the reproducing mode, main CPU 62 reads the image lastly captured from main memory 68 via memory control unit 64, and displays the read image on an LCD monitor 102 of display unit 100. When a user instructs “forward” or “backward” in function setting unit 116 in this state, the image captured before/after the currently displayed image is read and the read image is displayed on LCD monitor 102. Display unit 100 may display the image for which the image process is performed in image processing unit 220 and the image before the image process. For example, display unit 100 may display the image whose shift of ground and sky is changed and further displays both the image before the image process and information as to ground and sky in the image. The image process in image processing unit 220 is described.

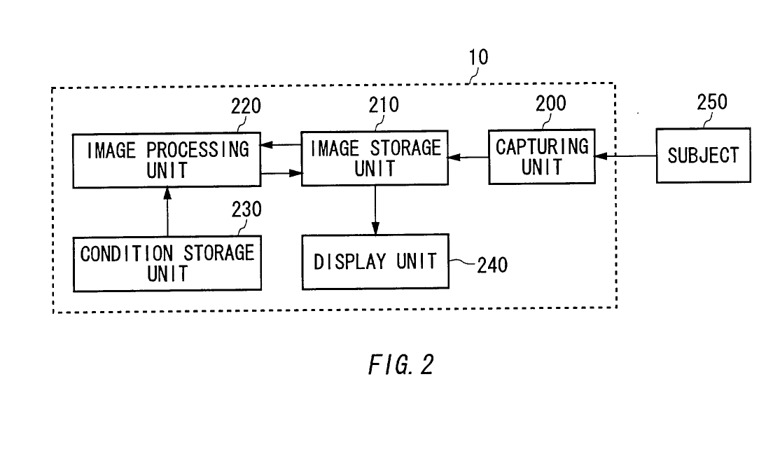

FIG. 2 is a block diagram for explaining one example of an image process in capturing apparatus 10. Capturing apparatus 10 includes capturing unit 200, image storage unit 210, image processing unit 220, condition storage unit 230, and display unit 240.

Capturing unit 200 has the same function and constitution or similar as/to capturing unit 38, capturing unit 20, capturing control unit 40, and capturing auxiliary unit 38 explained in FIG. 1 as one example, and captures an image of subject 250. Image storage unit 210 has the same function and constitution or similar as/to memory control unit 64 and nonvolatile memory 66 explained in FIG. 1 as one example, and stores an image captured by capturing unit 200. Condition storage unit 230 has the same function and constitution or similar as/to memory control unit 64, nonvolatile memory 66, and main memory 68 explained in FIG. 1 as one example and stores a detection condition to detect a predetermined subject element from an image in image processing unit 220.

Image processing unit 220 has the same function and constitution or similar as/to image processing unit 220 explained in FIG. 1, detects an image element corresponding to said subject element from an image based on a detection condition stored in condition storage unit 230, and performs an image process for the image so that the geometrical shift is reduced based on geometrical shift whose detected image element is from a predetermined reference.

Display unit 240 has the same function and constitution as/to display unit 100 explained in FIG. 1, and displays an image for which image processing unit 220 performs the image processing unit for an image which is captured by capturing unit 200. Below, the image process in image processing unit 220 is described in detail.

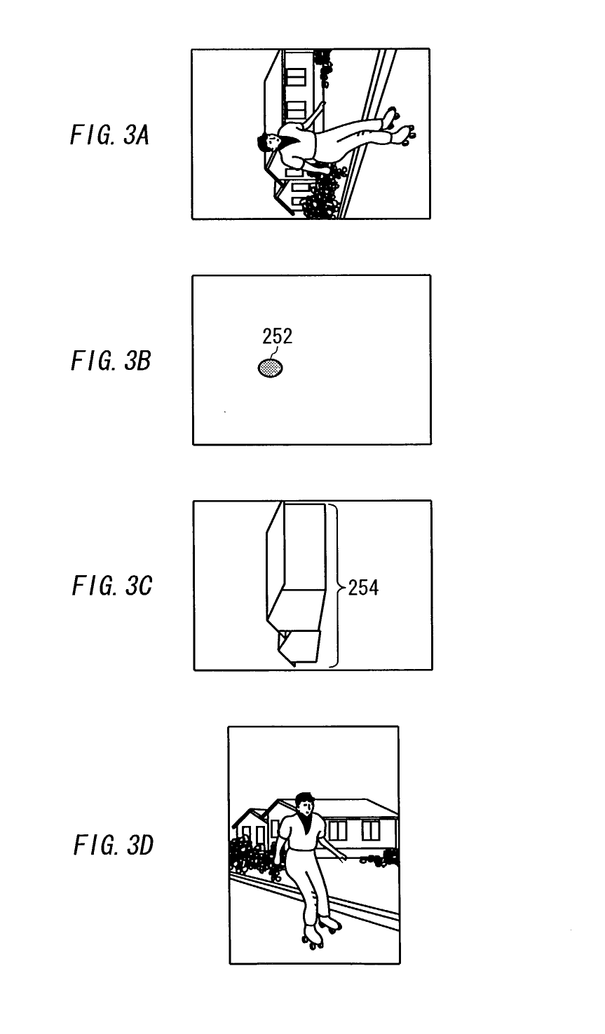

FIGS. 3A to 3D are views for explaining one example as to the image process in an image processing unit 220. In the present embodiment, image processing unit 220 detects shift of ground and sky in an image captured by capturing unit 200, and performs the image process to correct shift. In a case where image processing unit 220 performs the image process to correct shift of ground and sky in an image, condition storage unit 230 explained in FIG. 2 stores a detection condition to detect the subject element in which information of ground and sky is predetermined.

FIG. 3A shows one example of the image as to the subject captured by capturing unit 200. Person, building, sky, ground, or the like is captured as the subject in the image shown in FIG. 3A. Ground and sky of an image frame are not consistent with those of the subject in the image as shown in FIG. 3A. Generally, long edges of the image are the sky side and the ground side such as the image of FIG. 3A. In the image shown in FIG. 3A, ground and sky of the subject have an angle shift of 90 degree with respect to ground and sky of the image frame due to tilt of capturing apparatus 10 at a time of capture. Image processing unit 220 in the present embodiment corrects shift of ground and sky.

First, image processing unit 220 detects the image element corresponding to the predetermined subject element from an image based on a detection condition stored in condition storage unit 230. Image processing unit 220 detects image element 252 corresponding to a face of the person as shown in FIG. 3B. Image processing unit 220 may detect the image element suitable for detection condition based on an edge of each subject element in the image. Image processing unit 220 may detect the image element based on color information in each subject element. For example, in a case where image processing unit 220 detects the face of the person, image processing unit 220 detects image element 252 corresponding to the face of the person based on a shape of each subject element, color information of each subject element, and information whether or not eyes, a nose and/or a mouth are/is included in each subject element based on the edge of each subject element. In this case, condition storage unit 230 stores shape information of the face of the person, color information, and information of components of the face, and information of ground and sky as to the face of the person to detect the face of the person.

Next, image processing unit 220 determines ground or sky of an image based on information of ground and sky in the detected image element. In the present embodiment, condition storage unit 230 stores information of ground and sky in the image element corresponding to a detection condition. In the present embodiment, image processing unit 220 determines that a left edge of an image is the sky side and a right edge is the ground side based on information of ground and sky in image element 252. Image processing unit 220 reduces shift of at least one of the pieces of information of ground or sky in the detected image element from the predetermined reference based on the detection condition. For example, image processing unit 220 performs the image process so that shift of the reference from information of ground and sky in the detected image element as information as to ground and sky of the image frame in the captured image (image for which image captured is performed) which is the predetermined reference. In the present embodiment, since information of ground and sky in the image frame has an angle shift of 90 degree from information of ground and sky for the subject, image processing unit 220 rotates 90 degree for an image captured by capturing unit 200 as shown in FIG. 3B.

Image processing unit 220 may detect a plurality of image elements suitable for the detection condition and determine ground or sky of an image based on the detected plurality of image elements. In this case, image processing unit 220 may determine ground or sky of the image based on the image element whose image region is maximum among the detected plurality of image elements. Image processing unit 220 may determine ground or sky of the image based on the image element at the closest position to the center of the image among the detected plurality of image elements. Image processing unit 220 may determine ground or sky of an image for each detected image element, and determine ground or sky of an image so as to be the largest number of image elements for which ground and sky are suitable.

Condition storage unit 230 may store the plurality of detection conditions. For example, condition storage unit 230 may store a detection condition to detect the face of the person, sky, ground, building, or the like as the subject element. In this case, image processing unit 220 may detect the plurality of image elements based on the plurality of detection conditions, and determine ground or sky of the image based on the detected plurality of image elements.

Condition storage unit 230 may store color information of one example as a detection condition to detect sky or ground. In a case where predetermined color is continued at the predetermined number of pixel times in color information of the subject of an image, image processing unit 220 may perform the image process with the subject as sky or ground. For example, condition storage unit 230 stores color information corresponding to each weather state such as clear, cloud, or rain and image processing unit 220 may perform the image process as the region at which color suitable for any color is continued at the predetermined number of pixel times which is sky. Condition storage unit 230 stores color information corresponding to each of earth or asphalt, and image processing unit 220 may perform the image process as the region at which color suitable for any color information is continued at the predetermined number of pixel times which is ground. In this case, image processing unit 220 may determine that the region of sky is the sky side and the region of ground is the ground side in an image. In a case where a region where change of a color level is in a predetermined range is more than the predetermined number of pixel times, image processing unit 220 may perform the image process for the region as sky or ground.

Condition storage unit 230 may store shape information on the subject of one example as a detection condition to detect a building. As shown in FIG. 3C, image processing unit 220 may detect the edge of the subject and detect image element 254 corresponding to a building based on the detected edge and shape information on the subject. Image processing unit 220 corrects changes of ground and sky of the image based on information of ground and sky for a building stored in condition storage unit 230.

Image processing unit 220 may detect the plurality of image elements based on the plurality of detection conditions stored in condition storage unit 230, and determine ground or sky of the image based on the detected plurality of image elements. For example, image processing unit 220 may detect image element 252 corresponding to the face of the person and image element 254 corresponding to a building as shown in FIGS. 3B and 3C, and determine ground or sky of the image in FIG. 3A based on the detected image element 252 and image element 254. In this case, image processing unit 220 may assign weight to the detected plurality of image elements based on a detection condition, and determine ground or sky of the image. For example, condition storage unit 230 stores, and a coefficient of assigned weight corresponding to a plurality of detection conditions, and each detection condition, and image processing unit 220 marks directions of ground and sky in the detected plurality of image elements as a point based on the coefficient of assigned weight, and determines that a direction with the highest point is a sky direction-or a ground direction.

Image processing unit 220 may assign priority order for the detected plurality of image elements based on a detection condition, and determine ground or sky in the image based on the image element with a high order of priority. For example, condition storage unit 230 stores the order of priority corresponding to the plurality of detection conditions and each detection condition, and image processing unit 220 determines ground or sky of the image based on the image element of the highest order of priority corresponding to the detection conditions among the detected plurality of image elements.

According to the image process as described above, it is possible to easily determine ground or sky of the image based on information of ground and sky in the detected image element. Further, it is possible to easily correct geometrical shift of the reference as to predetermined information of ground or sky such as the ground directions of ground and sky in the image frame from information of ground and sky in the image. In the present embodiment, image processing unit 220 performs the image process for a rectangle image, however, it is obvious that image processing unit 220 can determine ground or sky for another image with other shapes, such as circular, in another embodiment. In this case, preferably, the reference as to ground and sky in the image is previously given to capturing apparatus 10. In the present embodiment, image processing unit 220 reduces geometrical shift of ground and sky in the image from ground and sky on the image frame by rotation of 90 degree for the image, however, in another embodiment, image processing unit 220 may finely adjust geometrical shift of ground and sky in the image from ground and sky in the image frame by rotation below 90 degree for the image.

In the present embodiment, image storage unit 210 stores an image for which image processing unit 220 performs the image process. For example, image storage unit 210 may store the image whose geometrical shift of image is reduced by image processing unit 220. Image storage unit 210 may store an image captured by the capturing unit and information of ground or sky in the image judged by image processing unit 220 corresponding to the image. Display unit 240 displays the image stored in image storage unit 210 and information of ground and sky. For example, display unit 240 may display the image of reduced geometrical shift stored in image storage unit 210. Display unit 240 may display the image stored in image storage unit 210 and information of ground and sky corresponding to image information. Display unit 240 may display the image, captured by capturing unit 200 for which the image process is not performed, stored in image storage unit 210 together with information of ground and sky in the image determined by image processing unit 220.

Display unit 240 may display a plurality of shrunken images, whose geometrical shift is reduced, stored in image storage unit 210. Display unit 240 may display the plurality of shrunken images and information of ground and sky corresponding to each of the plurality of images. A case where display unit 240 displays the plurality of images is described below.

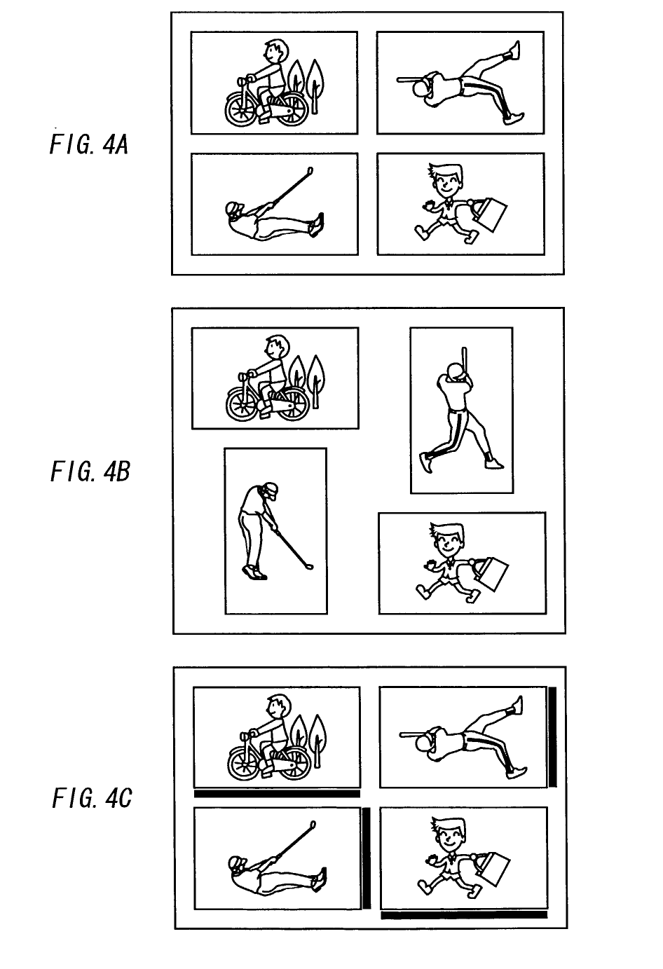

FIGS. 4A to 4C show an exemplary display in display unit 240. FIG. 4A is an example in a case where display unit 240 displays the plurality of images captured by capturing unit 200 without the image process. In this case, display unit 240 displays the image to justify the reference as to ground and sky of the image frame as ground and sky of the image. In FIG. 4A, since directions of ground and sky in the images of the top right and the bottom left are not consistent with ones in the other images, it is difficult for a viewer to see a constitution.

FIG. 4B shows an example of a case where display unit 240 displays the plurality of images whose directions of ground and sky are corrected by image processing unit 220. The images of the top right and the bottom left are images whose directions of ground and sky are corrected by image processing unit 220. Since the directions in the displayed image are in the same direction on the same screen, an image is easily recognized by the viewer.

FIG. 4C shows an example of a case where display unit 240 displays an image and information of ground and sky. In the present embodiment, the direction of ground for each image is shown by a bold line. Since information as to ground and sky of an image is displayed corresponding to an image, the image is easily recognized by the viewer. In the present embodiment, the direction of ground in an image is shown by the bold line. However, it is obvious that information of ground and sky on an image may be shown by other methods.

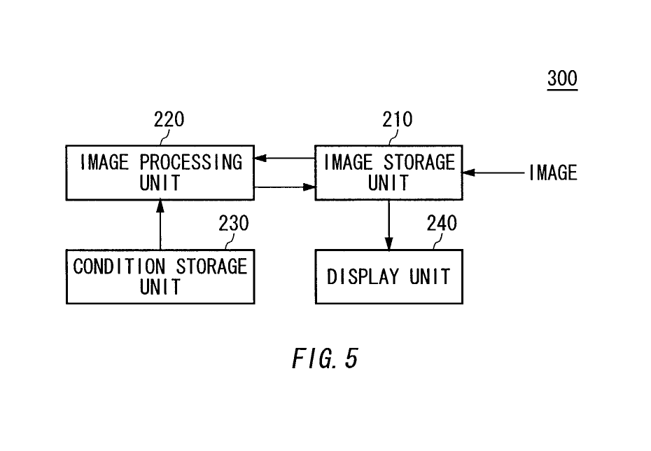

FIG. 5 is a block diagram showing one example of image processing apparatus 300 according to the present invention. Image processing apparatus 300 is, for example, a computer having a display apparatus and performs the image process for a given image. Image processing apparatus 300 provides image storage unit 210, image processing unit 220, condition storage unit 230, and display unit 240. Image storage unit 210 has the same function and constitution or similar as/to image storage unit 210 explained referring to FIGS. 2 to 4C, and stores the given image. Condition storage unit 230 has the same function and constitution or similar as/to condition storage unit 230 explained referring to FIGS. 2 to 4C, and stores a detection condition to detect the predetermined subject element from an image stored in image storage unit 210.

Image processing unit 220 has the same function and constitution or similar as/to image processing unit 220 explained referring to FIGS. 2 to 4C, detects the image element corresponding to the subject element from the image stored in image storage unit 210 based on the detection condition to detect the subject element stored in condition storage unit 240, and performs the image process for the image based on geometrical shift of the detected image element from the predetermined reference so that geometrical shift is reduced.

For example, image processing unit 220 performs the image process for the image so that shift of information of ground and sky on the image from the reference as to ground and sky of the image frame similar to image processing unit 220 explained referring to FIGS. 2 to 4C. Image processing unit 220 may correct deviation of the image from a character of a lens etc. or perform the image process such as trimming in a case where the subject, which is intended to be captured, is too close to the end of the image or an unnecessary subject such as sky occupies most of the images.

Display unit 240 has the same function and constitution or similar as/to display unit 240 explained referring to FIGS. 2 to 4C, and displays an image for which image processing unit 220 performs the image process. Display unit 240 may display a given image together with information of ground and sky corresponding to the given image.

According to image processing apparatus 300 in the present embodiment, it is possible to easily determine ground and sky of an image based on information of ground and sky in the detected image element. Further, is possible to easily correct geometrical shift of the predetermined reference as to ground and sky such as the directions of ground and sky on the image frame from ground and sky on the image.

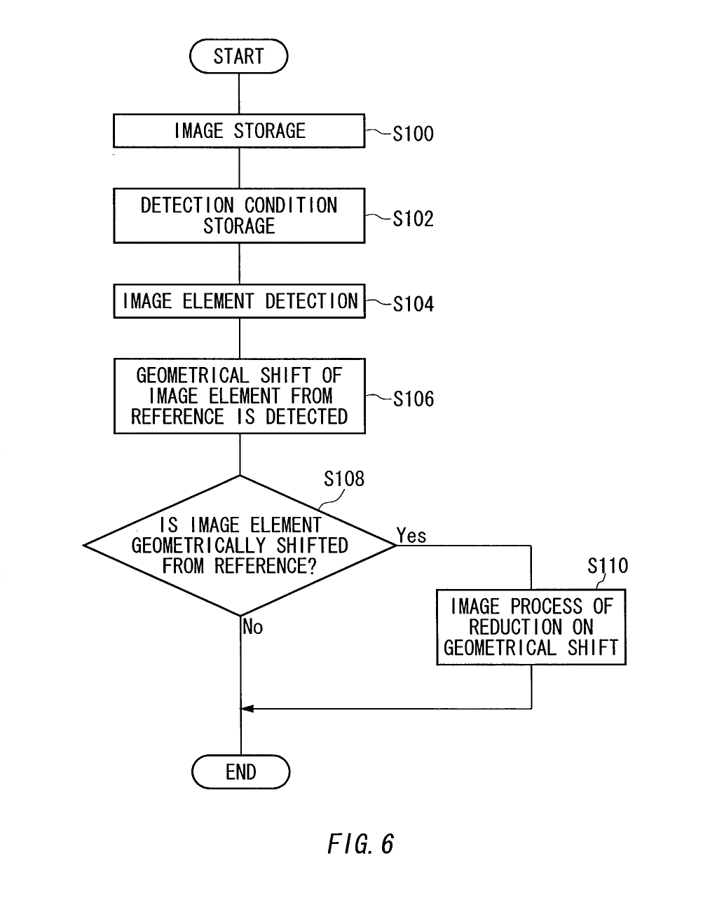

FIG. 6 shows one example of a flowchart as to an image processing method according to the present invention. The image processing method in the present embodiment is a method of performing the same process or similar as/to the image process in image processing apparatus 300 explained referring to FIG. 5. A given image is stored by an image storage step (S100). In the image storage step, a process is performed similar to a process in image storage unit 210 explained referring to FIG. 5. A detection condition to detect the predetermined subject element from the given image is stored by a condition storage step (S102). In the condition storage step, a process is performed similar to a process in condition storage unit 230 explained referring to FIG. 5. Either the image storage step or the condition storage step may previously be performed.

Geometrical shift of an image is reduced by the image processing procedure. In an image step (S104 to S110), a process is performed similar to a process in image processing unit 220 explained referring to FIG. 5. In the image processing step, the image element corresponding to the subject element is detected from the image based on detection condition (S104). Geometrical shift of the detected image element from the predetermined reference is detected (S106). In S106, for example, shift of information of ground and sky in the image element from the reference as to ground and sky of the image frame is detected. It is determined whether or not the image element is geometrically shifted from the predetermined reference (S108). In a case where geometrical shift does not occur, a process of the image processing method is ended. In a case where the geometrical shift occurs, the image process for the image is performed so that geometrical shift is reduced (S110). In S110, for example, the image process for the image is performed so that shift of information of ground and sky in an image from the reference as to sky and ground of the image frame is reduced, as explained referring to FIGS. 3A to 3D.

According to the image processing method as described above, it is possible to easily determine ground and sky of a given image based on ground and sky of information as to the image element detected from the given image. It is possible to easily change geometrical shift of the predetermined reference as to the ground and sky such as, for example, the directions of ground and sky as to the image frame from ground and sky on the image.

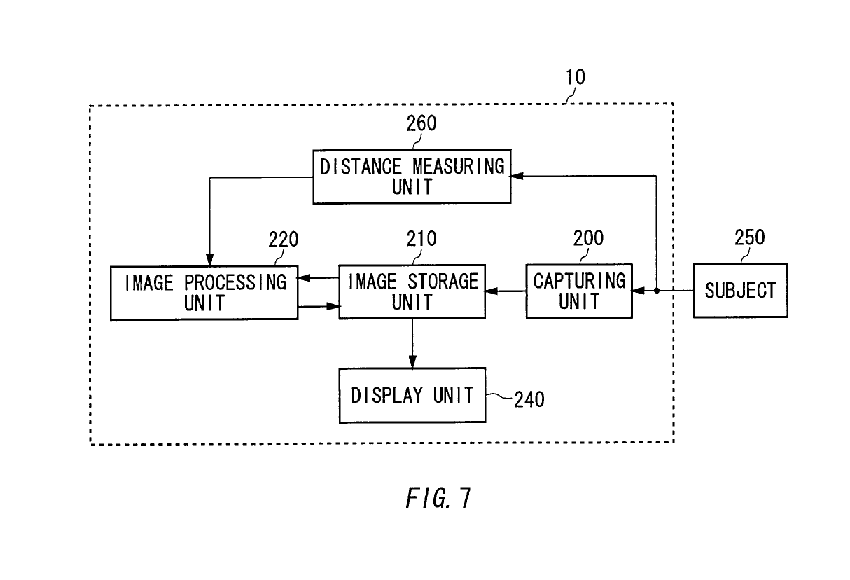

FIG. 7 is a block diagram for explaining another example of the image process in capturing apparatus 10. Capturing apparatus 10 includes capturing unit 200, image storage unit 210, image processing unit 220, distance measuring unit 260, and display unit 240.

Capturing unit 200 may have the same function and constitution or similar as/to capturing unit 200 explained referring to FIG. 2. Capturing unit 200 has the same function and constitution or similar as/to capturing unit 20, capturing control unit 40, and capturing auxiliary unit 38 explained referring to FIG. 1 as one example, and captures an image of subject 250.

Image storage unit 210 may have the same function and constitution or similar as/to image storage unit 210 explained referring to FIG. 2. Image storage unit 210 has the same function and constitution or similar as/to memory control unit 64 and nonvolatile memory 66 explained referring to FIG. 1, and stores an image captured by capturing unit 200.

Distance measuring unit 260 has the same function and constitution or similar as/to measuring sensor 52, sight meter sensor 54 and capturing system CPU 50 explained referring to FIG. 1 as one example, and obtains distance information of distance to subject 250 from capturing apparatus 10. Distance measuring unit 260 obtains distance information at the plurality of points of subject 250 in the image at the time of capturing the image in capturing unit 200.

Image processing unit 220 has the same function and constitution or similar as/to image processing unit 220 explained referring to FIG. 1, and determines ground and sky of the image based on distance information to the subject obtained by distance measuring unit 260.

Display unit 240 may have the same function and constitution or similar as/to display unit 240 explained referring to FIG. 2. Display unit 240 has the same function and constitution or similar as/to display unit 100 explained referring to FIG. 1, and displays the image for which the image process is performed by image processing unit 220 or the image captured by capturing unit 200. The image process in image processing unit 220 is described below.

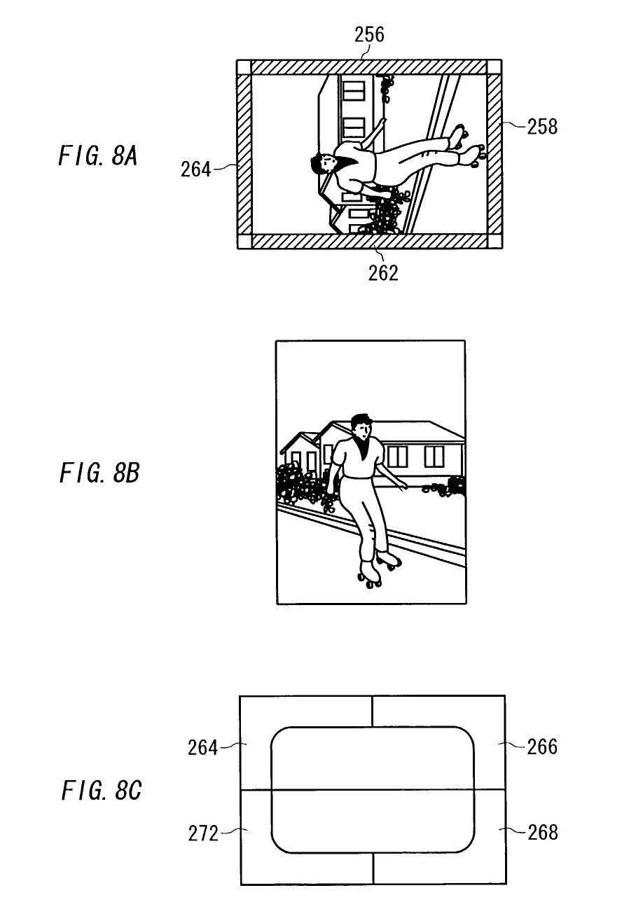

FIGS. 8A to 8C are views for explaining one example of an image process in image processing unit 220. FIG. 8A shows one example of an image as to the subject captured by capturing unit 200. Person, building, sky, ground, or the like is captured as the subject in an image shown in FIG. 8A. Ground and sky of the image frame are not consistent with ground and sky of the subject in the image as shown in FIG. 8A. Generally, long edges of the image are the sky side and the ground side like the image of FIG. 8A as to ground and sky on the image frame. In the image shown in FIG. 8A, ground and sky of the subject have an angle shift of 90 degree with respect to ground and sky on the image frame due to tilt of capturing apparatus 10 at the time of capture. Image processing unit 220 in the present embodiment corrects shift of ground and sky.

Distance measuring unit 260 obtains distance information at the plurality of points on the subject in an image. Distance measuring unit 260 may obtain distance information of at least two edges of the image. In the present embodiment, distance measuring unit 260 obtains distance information of four edges of the image as shown FIG. 8A. Distance measuring unit 260 may obtain distance information on the subject in the pixel at a portion closest to the end of four edges in the image. Distance measuring unit 260 may obtain distance information of the subject in the pixel of a peripheral region of the four edges in the image.

Image processing unit 220 determines ground and sky of an image based on distance information obtained by distance measuring unit 260. For example, image processing unit 220 may determine that the subject to show distance information obtained by distance measuring unit 260 is a near distance among the subjects in the image is the ground direction. Image processing unit 220 may determine that the subject to show distance information obtained by distance measuring unit 260 is a far distance among the subjects in the image is the sky direction. Image processing unit 220 may determine ground and sky of image based on a mean value of distance information on each edge obtained by distance measuring unit 260. For example, image processing unit 220 may calculate a mean value of distance information in the pixel of the portion closest to the end of each edge in the image for each edge and determine that the edge whose mean value of distance information is the minimum is the ground side.

Image processing unit 220 may determine that the edge whose mean value of distance information is the maximum is the sky side. As shown in FIG. 8A, image processing unit 220 may calculate the mean value of distance information in the pixel of a peripheral region on each edge in the image for each edge, and determine that the edge whose mean value of distance information is the minimum is the ground side or the edge whose mean value of distance information is the maximum is the sky side.

A process in which the mean value of distance information in the pixel of the peripheral region of each edge on an image in image processing unit 220 is the minimum is the ground side is described below.

Distance measuring unit 260 obtains distance information of pixels of region 256, region 258, region 262, and region 264, which are the peripheral regions of the four edges in the image as shown in FIG. 8A. Image processing unit 220 calculates the mean value of distance information in the pixel for each of region 256, region 258, region 262, and region 264.

Image processing unit 220 detects the edge corresponding to the region whose calculated mean value is the minimum. Since the subject in region 258 is ground which is the closest to capturing apparatus 10 in the present embodiment, image processing unit 220 detects region 258 as the region whose mean value of distance information is the minimum, and performs the image process as the edge corresponding to region 258 which is the ground side. In the present embodiment, image processing unit 220 corrects shift of ground and sky in the image by rotation of 90 degree for the image as shown in FIG. 8B.

Capturing apparatus 10 measures distance to the subject with measuring sensor 52 to automatically adjust focus or diaphragm in capturing unit 200. For example, capturing apparatus 10 divides an image into a plurality of regions and adjusts focus or diaphragm based on measured distance to the subject in each region as shown in FIG. 8C. Image processing unit 220 may perform the aforementioned image process based on distance information to the subject measured by measuring sensor 52 to adjust focus or diaphragm. For example, image processing unit 220 performs the image process based on the following information. The mean value of distance information at region 264 and region 266 is distance information of an upper edge on an image, the mean value of distance information at region 264 and region 272 is distance information of a left edge on the image, the mean value of distance information at region 272 and region 268 is distance information of a lower edge on the image, and the mean value of distance information at region 268 and region 266 is distance information of a right edge on the image.

According to the image process as described above, it is possible to easily determine ground and sky of the image based on distance information of the subject in the image. Further, it is possible to easily correct geometrical shift of the predetermined reference as to ground and sky such as the directions of ground and sky on the image frame from ground and sky of the image. In the present embodiment, image processing unit 220 performs the image process for a rectangle image, however, it is obvious that image processing unit 220 can determine ground or sky for another image with the other shapes, such as circular, in another embodiment. In this case, preferably, the reference as to ground and sky in the image is previously given to capturing apparatus 10. In the present embodiment, image processing unit 220 reduces geometrical shift of ground and sky in the image from ground and sky on the image frame by rotation of 90 degree for the image, however, in another embodiment, image processing unit 220 may finely adjust geometrical shift of ground and sky in the image from ground and sky on the image frame by rotation below 90 degree for the image.

In the present embodiment, image storage unit 210 stores the image for which image processing unit 220 performs the image process. For example, image storage unit 210 may store the image whose geometrical shift of image is reduced by image processing unit 220. Image storage unit 210 may store the image captured by the capturing unit and information of ground and sky in the image judged by image processing unit 220 corresponding to the image.

Display unit 240 displays the image and information of ground and sky stored in image storage unit 210. For example, display unit 240 may display the image of reduced geometrical shift stored in image storage unit 210. Display unit 240 may display the image and information of ground and sky corresponding to image information stored in image storage unit 210. Display unit 240 may display both the image, captured by capturing unit 200 for which the image process is not performed, stored in image storage unit 210, and information of ground and sky in the image determined by image processing unit 220.

Display unit 240 may display a plurality of shrunken images, whose geometrical shift is reduced, stored in image storage unit 210. Display unit 240 may display the plurality of shrunken images and information of ground and sky corresponding to each of the plurality of images.

Image processing unit 220 may be operated based on a program stored in nonvolatile memory 66 or main memory 68 as shown in FIG. 1. Memory control unit 64 as shown in FIG. 1 may receive the program to operate image processing unit 220 from external devices via communication I/F unit 80, and store the received program into nonvolatile memory 66. Memory control unit 64 may receive the program to operate image processing unit 220 from optional unit 76, and store the received program into nonvolatile memory 66. The program stored into nonvolatile memory 66 or main memory 68, as one example, makes processing unit 60 function as the image storage unit to store the image, which needs to be processed and the image processing unit to determine ground or sky in the image based on supplied distance information at the plurality of points of the subject in the image.

The program may make the image processing apparatus such as a computer functionally be operated as described above. The process performed by processing unit 60 based on the program is the same function and operation or similar as/to image processing unit 220 and image storage unit 210 the same function and operation or similar as/to image processing apparatus 300, or the same function or similar as/to the image processing method as described later.

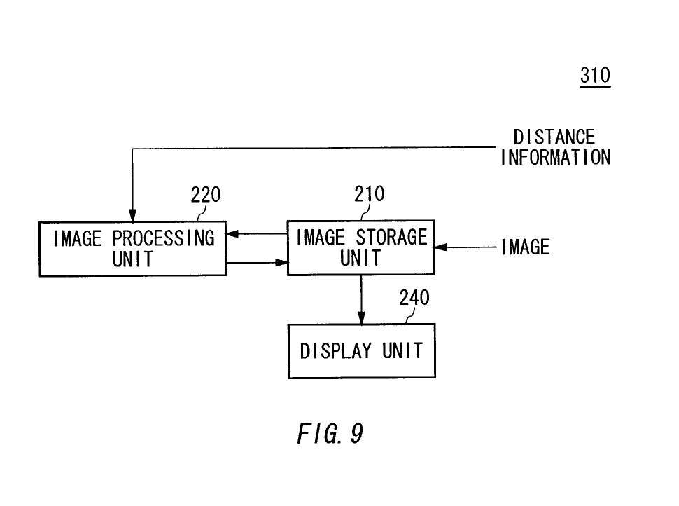

FIG. 9 is a block diagram showing one example of image processing apparatus 310 according to the present invention. Image processing apparatus 310 is, for example, the computer having the display apparatus, and performs the image process for a given image. Image processing apparatus 310 provides image storage unit 210, image processing unit 220, and display unit 240. Image storage unit 210 has the same function and constitution or similar as/to image storage unit 210 explained referring to FIG. 7, and stores the given image.

Image processing unit 220 has the same function and constitution or similar as/to image processing unit 220 explained referring to FIGS. 7 and 8A to 8C, distance information at each of the plurality of points of the subject in a given image are supplied, and image processing unit 220 judges ground or sky of the image based on supplied distance information.

Display unit 240 has the same function and constitution or similar as/to display unit 240 explained referring to FIGS. 7 and 8A to 8C, and displays an image for which the image process is performed by image processing unit 220. Display unit 240 may display the given image together with information of ground and sky corresponding to the given image.

In image processing apparatus 310 in the present embodiment, it is possible to easily determine ground and sky of a given image based on supplied distance information of the subject. It is possible to easily correct geometrical shift of the predetermined reference as to ground and sky such as the directions of ground and sky on the image frame from ground and sky of the image.

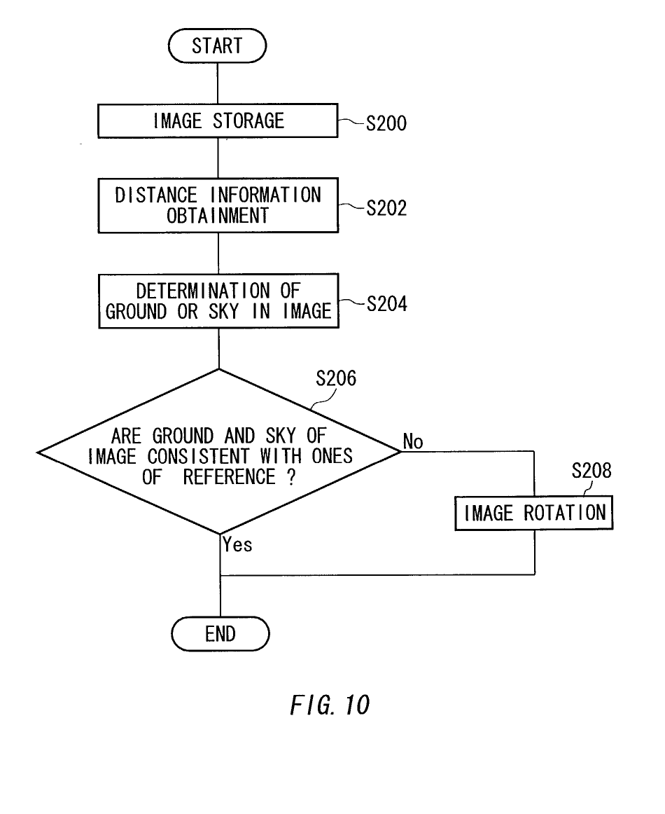

FIG. 10 shows one example of a flowchart as to an image processing method according to the present invention. The image processing method in the present embodiment is a method of performing the same process or similar as/to the image process in image processing apparatus 310 explained referring to FIG. 9. A given image is stored by an image storage step (S200). In the image storage step, a process is performed similar to a process in image storage unit 210 explained referring to FIG. 9. In the image processing step (S202 to S208), distance information at each of the plurality of points on the subject in the image is obtained, and ground and sky of the image is determined based on distance information. In the image processing step, a process is performed similar to a process of image processing unit 220 explained referring to FIG. 9. In the image processing step, distance information at each of the plurality of points on the subject in the image is obtained (S202). Sky or ground of the image is determined based on obtained distance information (S204) In S204, ground or sky of the image is determined by a method similar to a determination method explained referring to FIGS. 8A to 8C. It is determined whether or not ground and sky of the image are consistent with the reference as to, for example, ground and sky of the image frame (S206).

In a case where ground and sky of the image are consistent with the reference of ground and sky, the process of the image processing method is ended. In a case where ground and sky of the image are not consistent with the reference of ground and sky, the image is rotated so that ground and sky of the image are consistent with the reference as to ground and sky of the image frame (S208). In S208, the image is rotated so that the reference of ground and sky on the image frame are consistent with ground and sky of the image as explained referring to FIGS. 8A to 8C.

According to the image processing method, it is possible to easily determine ground and sky of a given image based on distance information of the subject in the given image. Further, it is possible to easily correct geometrical shift of the predetermined reference as to ground and sky such as, for example, the directions of ground and sky on the image frame from ground and sky of the image.

As is apparent from the above description, according to a capturing apparatus, an image processing apparatus, an image processing method, and a program in the present invention, it is possible to detect geometrical shift of an image, and to easily correct geometrical shift. For example, in a case where information of ground and sky in an image is shifted from a reference as to ground and sky of an image frame, it is possible to detect shift of ground and sky and to easily correct shift.

Although the present invention has been described by way of exemplary embodiments, it should be understood that many changes and substitutions may be made by those skilled in the art without departing from the spirit and the scope of the present invention which is defined only by the appended claims.

What is claimed is:

1. A capturing apparatus for capturing a subject, comprising:
a capturing unit for capturing image of said subject;
a condition storage unit for storing detection condition to detect a predetermined subject element from said subject; and
an image processing unit for detecting said image element corresponding to said subject element from image based on said detection condition and performing an image process for image based on geometrical shift of said detected image element from a predetermined reference so that said geometrical shift is reduced.

2. The capturing apparatus according to claim 1, further comprising an image storage unit for storing image captured by said capturing unit.

3. The capturing apparatus according to claim 2, wherein said condition storage unit for storing detection condition to detect a predetermined information of ground and sky, and said image processing unit for reducing shift of at least one of information of ground or sky in said image element from said predetermined reference.

4. The capturing apparatus according to claim 3, wherein said image processing unit performs image process for reducing shift of at least one of ground or sky information in said image element detected based on said detection condition from said reference as to predetermined ground and sky.

5. The capturing apparatus according to claim 4, wherein said image processing unit detects said image element suitable for said detection condition based on an edge of each subject element in image.

6. The capturing apparatus according to claim 4, wherein said image processing unit detects a plurality of image elements and judges ground or sky of image based on said detected plurality of image elements.

7. The capturing apparatus according to claim 6, wherein said image processing unit judges ground or sky of image based on an image element whose image region is maximum among said detected plurality of image elements.

8. The capturing apparatus according to claim 4, wherein said condition storage unit stores said plurality of detection conditions.

9. The capturing apparatus according to claim 8, wherein said image processing unit detects said plurality of image elements based on said plurality of detection conditions and judges ground or sky of image based on said detected plurality of image elements.

10. The capturing apparatus according to claim 9, wherein said image processing unit assigns weight to said detected plurality of image elements based on said detection condition and judges ground or sky of image.

11. The capturing apparatus according to claim 9, wherein said image processing unit gives said detected plurality of image elements priority based on said detection condition and judges ground or sky of image based on said image element of high priority.

12. The capturing apparatus according to claim 4, wherein said condition storage unit stores said detection condition to detect a face of a person as said subject element.

13. The capturing apparatus according to claim 4, wherein said condition storage unit stores said detection condition to detect sky as said subject element.

14. The capturing apparatus according to claim 4, wherein said condition storage unit stores said detection condition to detect ground as said subject element.

15. The capturing apparatus according to claim 4, wherein said image storage unit stores image captured by said image storage unit and information of ground or sky judged by said image processing unit corresponding to image.

16. The capturing apparatus according to any of claim 4, wherein said image storage unit stores image whose said geometrical shift is reduced by said image processing unit.

17. The capturing apparatus according to claim 15, further comprising a display unit for displaying image stored by said image storage unit and said information of ground and sky corresponding to image.

18. The capturing apparatus according to claim 16, further comprising said display unit for displaying image, whose said geometrical shift is reduced, stored by said image storage unit.

19. The capturing apparatus according to claim 17, wherein said display unit displays images whose said plurality of images are zoomed out and said information of ground and sky corresponding to each of said plurality of images.

20. The capturing apparatus according to claim 18, wherein said display unit displays said zoomed-out plurality of images whose said geometrical shift is reduced.

21. An image processing apparatus for performing an image process for given image, comprising:
an image storage unit for storing given image;
a condition storage unit for storing detection condition to detect a predetermined subject element from image;
an image processing unit for detecting said image element corresponding to said subject element from image based on said detection condition and performing an image process for image based on geometrical shift of said detected image element from a predetermined reference so that said geometrical shift is reduced; and
a display unit for displaying image for which an image process is performed by said image processing unit.

22. An image processing method for performing an image process for given image, comprising steps of:
storing given image;
storing detection condition to detect a predetermined subject element from image; and
detecting said image element corresponding to said subject element from image based on said detection condition and performing an image process for image based on geometrical shift of said detected image element from a predetermined reference so that said geometrical shift is reduced.

23. A computer readable medium recording a program for making an image processing apparatus perform an image process, wherein the program makes said image processing apparatus function as units for:
storing image for which an image process is performed;
storing detection condition to detect a predetermined subject element from image; and
detecting said image element corresponding to said subject element from image based on said detection condition and performing an image process for image based on geometrical shift of said detected image element from a predetermined reference so that said geometrical shift is reduced.

24. A capturing apparatus for capturing a subject, comprising:
a capturing unit for capturing image of said subject;
an image storage unit for storing image captured by said capturing unit;
a distance measuring unit for obtaining distance information at each point of a plurality of points of said subject in image at a time of capturing image in said capturing unit; and
an image processing unit for judging ground or sky of image based on said distance information obtained by said distance measuring unit.

25. The capturing apparatus for capturing a subject according to claim 24, wherein said image processing unit judges that a subject showing distance information as far among subjects in image is a sky direction and a subject showing distance information obtained by said distance measuring unit as near is a ground direction.

26. A capturing apparatus according to claim 25, wherein said distance measuring unit obtains distance information of said subject of at least two edges of image, and said image processing unit judges ground or sky of image based on a mean value for distance information of each edge obtained by said distance measuring unit.

27. The capturing apparatus according to claim 26, wherein said image processing unit judges that an edge whose said mean value for distance information in image is the sky side.

28. An image processing method of performing an image processing for given image, comprising:
an image storage unit for storing image;
an image processing unit for receiving distance information at each point of a plurality of points of a subject in image and for judging ground or sky of image based on said distance information; and
a display unit for displaying image for which said image processing unit performs an image process.

29. An image processing method of performing an image processing for given image, comprising steps of:
storing given image; and
receiving distance information at each point of a plurality of points of a subject in image and for judging ground or sky of image based on said distance information.

30. A computer readable medium recording a program for making an image processing apparatus execute an image process, wherein said program makes said image processing apparatus function as units for:
storing image for which an image process is performed; and
receiving distance information at each point of a plurality of points of a subject in image and for judging ground or sky of image based on said distance information.
